(19) United States
(12) Patent Application Publication
(10) Pub. No.: US 2007/0210497 A1
(43) Pub. Date: Sep. 13, 2007

(54) Front engine isolator mount

(75) Inventors: Christopher K. Furman, Augusta, GA (US); James Agerton II, Augusta, GA (US); Edgar Grigsby JR., Augusta, GA (US)

Correspondence Address: HARNESS, DICKEY & PIERCE, P.L.C., P.O. BOX 828, BLOOMFIELD HILLS, MI, 48303, US

(73) Assignee: Textron Inc., Providence, RI (US)

(21) Appl. No.: 11/365,897

(22) Filed: Feb. 28, 2006

(51) Int. Cl. F16F 13/00

(52) U.S. Cl. 267/140.13

(57) ABSTRACT

An engine isolator mount can be utilized to couple a front portion of a drive unit including an internal combustion engine assembly to the frame of a small utility vehicle. The engine isolator mount can allow for limited relative movement between the engine and the frame during acceleration and deceleration and operation of the small utility vehicle. The engine isolator mount can be configured to undergo compression during forward deceleration and tension during forward acceleration of the small utility vehicle. The engine isolator mount can allow relative movement in all three directions.

### FIELD

The present disclosure relates to an engine isolator mount, for example, in small utility vehicles.

### BACKGROUND

The statements in this section merely provide background information related to the present disclosure and may not constitute prior art.

Small utility vehicles can include: golf cars, shuttle personnel carriers, refreshment vehicles, industrial utility vehicles and/or trail utility vehicles. These small utility vehicles can use a drive unit, which may include an internal combustion engine assembly, to drive movement of the vehicle. Typically, one portion of the combustion engine assembly is attached to the rear drive axle which is mounted to the frame of the small utility vehicle. Another portion of the combustion engine assembly is coupled to the frame with a metallic clevis joint assembly which is bolted to a cross member that extends between fore-and-aft extending rails of the frame. Acceleration and deceleration of the small utility vehicle may induce rotation of the engine assembly about the rear drive axle. The rotation of the engine assembly is limited by the clevis joint assembly. A rubber insulating piece may be utilized in the clevis joint assembly. The use of a clevis joint assembly with the rubber piece, however, requires multiple parts that increase the complexity and expense of the clevis joint assembly. Additionally, the movement of the engine assembly relative to the vehicle results in metal-on-metal contact in the clevis joint assembly which can cause protective coatings thereon to be worn off and may result in corrosion of these metal components.

Accordingly, it can be advantageous to economically provide an engine isolator mount that is less complex and utilizes less parts. Additionally, it can be advantageous if an engine mount eliminated metal-to-metal contact.

### SUMMARY

An engine isolator mount for small utility vehicles is provided in the present disclosure. The engine mount allows for coupling a front portion of the drive unit to the frame of the small utility vehicle. The engine mount allows for limited relative movement between the drive unit and the frame during acceleration and deceleration of the small utility vehicle.

An engine isolator mount according to the present disclosure can include a single resilient member having opposite first and second ends spaced apart in a first direction with a central section extending therebetween. Opposite first and second surfaces spaced apart in a second direction different than the first direction. The first and second end sections can each have a respective first and second through opening extending between the first and second surfaces. The first and second openings can deform to allow rigid members to be disposed therethrough and can allow limited relative movement between rigid members disposed therein.

An engine isolating mounting system according to the present disclosure can include an internal combustion engine assembly having an internal combustion engine and a first tongue member coupled thereto. A frame can have a second tongue member coupled thereto. A unitary-resilient isolating member can have spaced-apart end sections with a central section therebetween. Each end section can have a through opening extending therethrough. The first and second tongue members can each be disposed in one of the through openings.

A small utility vehicle according to the present disclosure can include a longitudinally-extending frame having a first mounting member coupled thereto. A drive axle assembly can be coupled to the frame. The drive axle assembly can include at least one transversely-extending drive axle and at least one driven wheel coupled to the at least one drive axle. An internal combustion engine assembly can be coupled to the drive axle assembly. The internal combustion engine assembly can have a second mounting member coupled thereto. A unitary resilient isolating member can be coupled to the first and second mounting members. The isolating member can include upper and lower end sections with a central section extending therebetween. The end sections can each have a longitudinally-extending through opening with the first and second mounting members each disposed in and longitudinally extending through different ones of the through openings.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of a small utility vehicle configured as a golf car, in accordance with the present disclosure;

FIG. 2 is a perspective view of a frame and internal combustion engine assembly mounted thereto utilizing an engine isolator mount according to the present teachings;

FIG. 3 is an enlarged fragmented perspective view of a portion of the frame and engine assembly of FIG. 2;

FIG. 4 is another enlarged fragmented perspective view of a portion of the frame and engine assembly of FIG. 2;

FIG. 5 is a perspective view of an engine isolator mount utilized to mount the internal combustion engine assembly to the frame according to the present teachings;

FIG. 6 is a front plan view of the engine mount of FIG. 5;

FIG. 7 is a cross-sectional view along line 7-7 of FIG. 5;

FIG. 8 is a perspective view of a bracket including a tongue that engages with the engine mount according to the present teachings;

FIG. 9 is a top plan view of the tongue of FIG. 8;

FIG. 10 is a side plan view of the tongue of FIG. 8;

FIG. 11 is a perspective view of an engine pan for the bottom of an internal combustion engine assembly including a tongue that engages with the engine mount according to the present teachings;

FIG. 12 is a top plan view of the tongue portion of the engine pan of FIG. 11; and

FIG. 13 is a side plan view of the tongue portion of the engine pan of FIG. 11.

### DESCRIPTION

The following description is merely exemplary in nature and is in no way intended to limit the present disclosure, application, or uses. Throughout this specification, like reference numerals will be used to refer to like elements.

According to the present disclosure, an engine isolator mount can be utilized to couple a front portion of a drive unit including an internal combustion engine assembly to the frame of a small utility vehicle. The engine isolator mount can allow for limited relative movement between the engine and the frame during acceleration and deceleration and operation of the small utility vehicle. The engine isolator mount can be configured to undergo compression during forward deceleration and tension during forward acceleration of the small utility vehicle. The engine isolator mount can allow relative movement in all three directions.

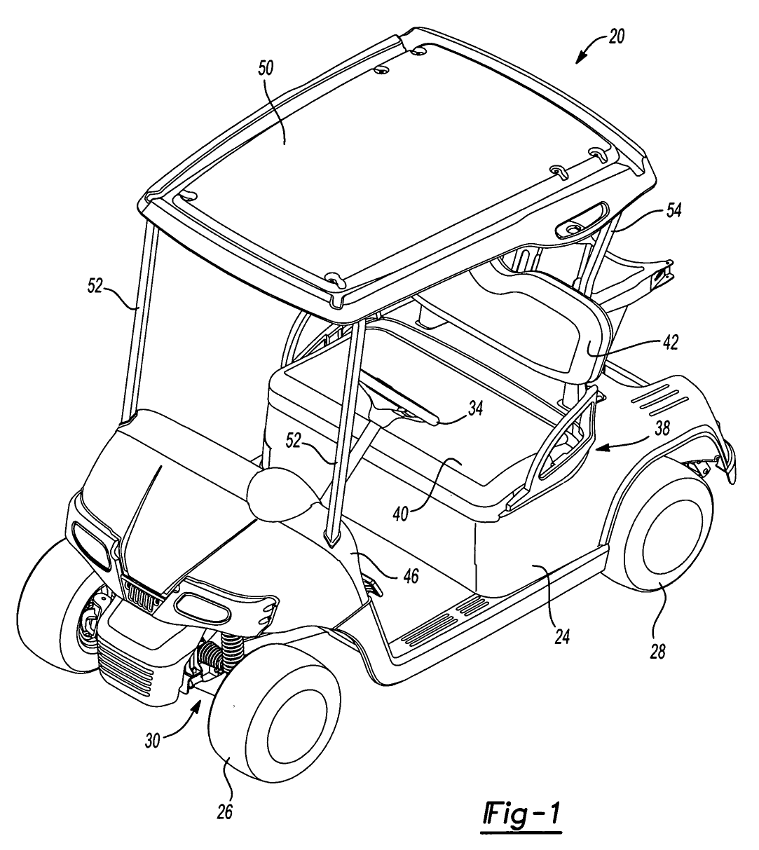

Referring to FIG. 1, an exemplary small utility vehicle 20, in this case in the form of a golf car, according to the present disclosure is shown. As used herein, the term “small utility vehicle” includes, but is not limited to, golf cars, shuttle personnel carriers, refreshment vehicles, industrial utility vehicles and/or trail utility vehicles. Also as used herein, the term “longitudinal” refers to a direction corresponding to a fore-and-aft direction relative to vehicle 20 and the term “transverse” refers to a direction corresponding to a cross-vehicle direction relative to the vehicle 20, which is generally perpendicular to the fore-and-aft direction.

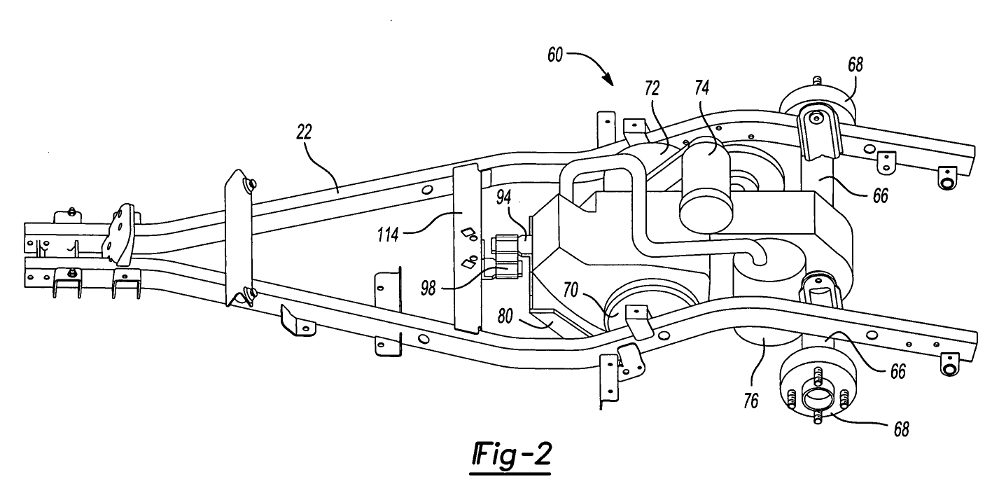

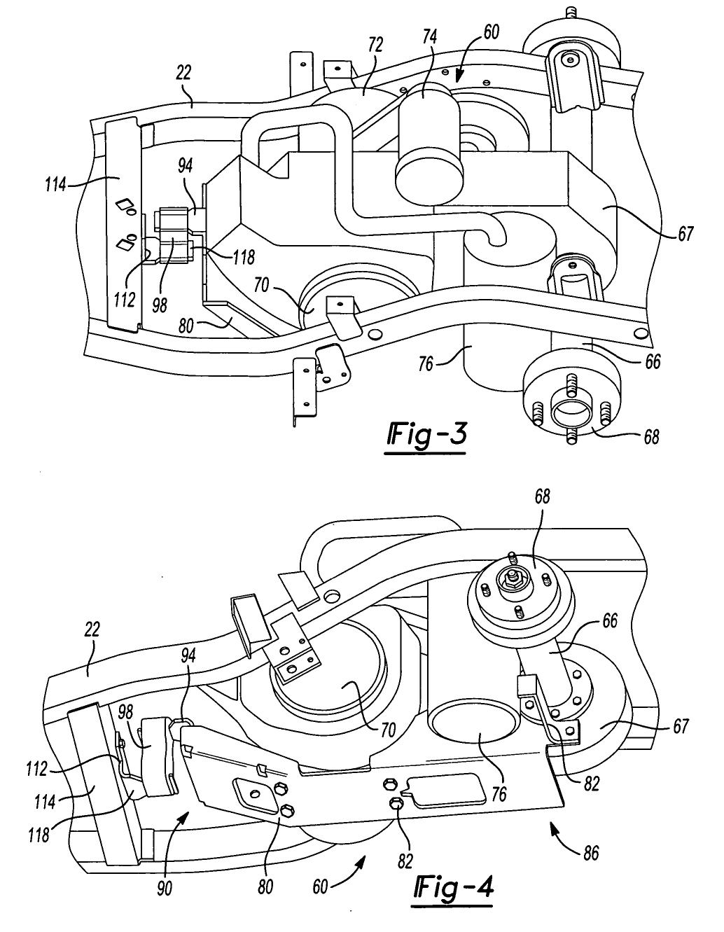

Vehicle 20 includes various components that are mounted to a frame 22, shown in FIGS. 2-4, which may vary based upon the configuration or type of small utility vehicle. Vehicle 20 can include a body 24 supported from frame 22. Frame 22 can also support a plurality of wheels including steerable wheels 26 in addition to powered or driven wheels 28. A front suspension system 30 can be used to support steerable wheels 26. Driven wheels 28 are commonly connected to a structural portion of frame 22 with a rear suspension system (not shown) which can include leaf springs and shock absorbers. A steering mechanism 34, which commonly includes a steering wheel and a support post assembly, can also be included to provide the steering inputs to steerable wheels 26.

Vehicle 20 may also include a front seating area 38 including a bench seat 40 and a back support cushion 42. An instrument panel 46 can be included and may house various components, such as instruments controlling the operation of vehicle 20 and/or indicating the operational status of vehicle 20, along with storage compartments and the like by way of non-limiting example. A cover or roof 50 can be provided which is supported from either frame 22 or body 24 by front and rear canopy struts 52, 54. A windscreen or windshield (not shown) can also be provided which can be supported by each of the front canopy struts 52. Other items that can be provided when vehicle 20 is in the form of a golf car include golf bag support equipment, accessory racks or bins, headlights, side rails, fenders and the like. Moreover, when vehicle 20 is configured as other types of vehicles, a rear-facing seat or multiple rows of seats may be included, a storage bed (tiltable or fixed) may be attached to the rear portion of vehicle 20, beverage compartments may be attached to the rear portion of vehicle 20 and the like, by way of non-limiting example.

Vehicle 20 can be propelled by a power unit 60, shown in FIGS. 2-4, which is commonly disposed behind or below bench seat 40. Power unit 60, as shown, can be an internal combustion engine assembly that can include an internal combustion engine. A drive axle 66 including a gear assembly 67 can interconnect driven wheels 28. Power unit 60 can be coupled to gear assembly 67 to drive driven wheels 28 with drive axle 66. Drive axle 66 includes hubs 68 that driven wheels 28 can be attached to. Drive axle 66 can be coupled to frame 22 by the rear suspension system. The rear suspension system can allow drive axle 66 to move relative to frame 22 during operation of vehicle 20. The movement of drive axle 66 can also cause movement of power unit 60 relative to frame 22. Power unit 60 enables driven wheels 28 to propel vehicle 20 in both a forward and rearward direction with steering provided by steerable wheels 26 via input from steering mechanism 34.

Vehicle 20 can also include a braking system that enables braking (deceleration) of the movement of vehicle 20. Power unit 60 can include an internal combustion engine 70, a clutch mechanism 72 coupled to gear assembly 67, a starter 74 and a muffler 76 thereby forming a combustion engine assembly. The lower portion of power unit 60 can include an engine pan 80 to which internal combustion engine 70 is attached, such as by way of fasteners 82. Engine pan 80 can provide a structural support and mountings for the various components of power unit 60. Engine pan 80 can form a protective lower casing for power unit 60 that protects the various components from contact with obstacles encountered in operation of vehicle 20.

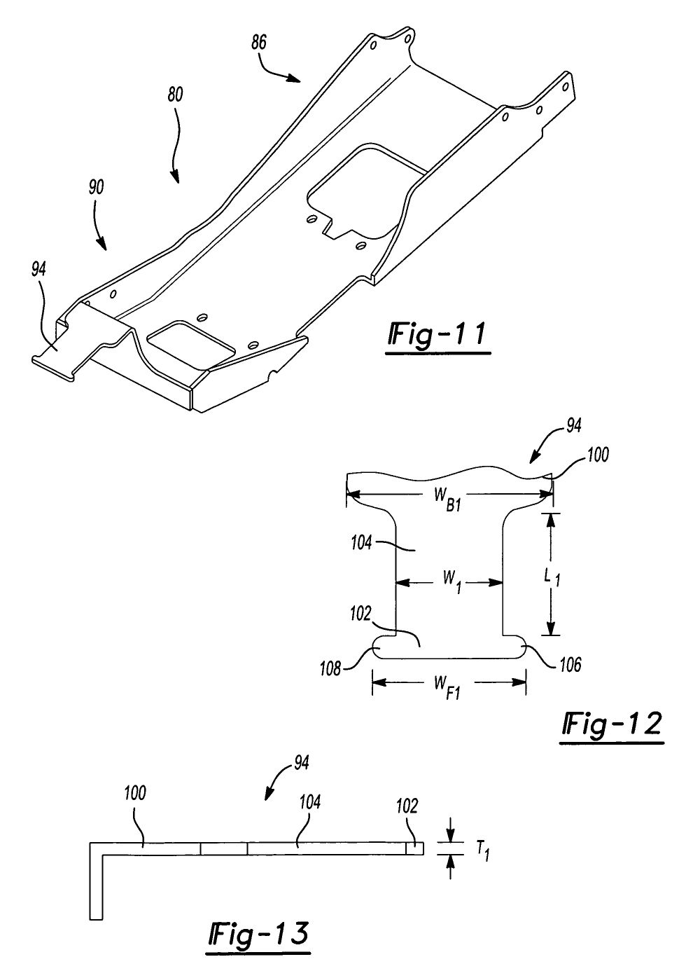

Referring now to FIGS. 4 and 11-13, a rear portion 86 of engine pan 80 is coupled to drive axle 66 via gear assembly 67. Rear portion 86 of engine pan 80 can thereby support power unit 60 from drive axle 66 which is coupled to frame 22 by the rear suspension system. A front portion 90 of engine pan 80 can also be used to support power unit 60 from frame 22. Front portion 90 of engine pan 80 can include a tongue 94 that extends longitudinally. Tongue 94 can be coupled to an engine isolator mount 98 that in turn can be coupled to frame 22. Tongue 94 can include longitudinally-opposite base and end sections 100, 102 with an elongated section 104 extending longitudinally therebetween. Tongue 94 can have a generally uniform thickness T₁ in the vertical direction. Elongated section 104 can have a generally uniform transverse width W₁. Base section 100 can have a maximum transverse width W_{B1} and can taper transversely inwardly as base section 100 approaches elongated section 104. End section 102 can include transversely-outwardly-extending flanges 106, 108 that extend transversely outwardly beyond elongated section 104 and have a transverse width W_{F1}. Flanges 106, 108 can retain tongue 94 in engine mount 98, as described below. Elongated section 104 can have a longitudinal length L₁ between base and end sections 100, 102. Engine pan 80 and tongue 94 can be made of steel.

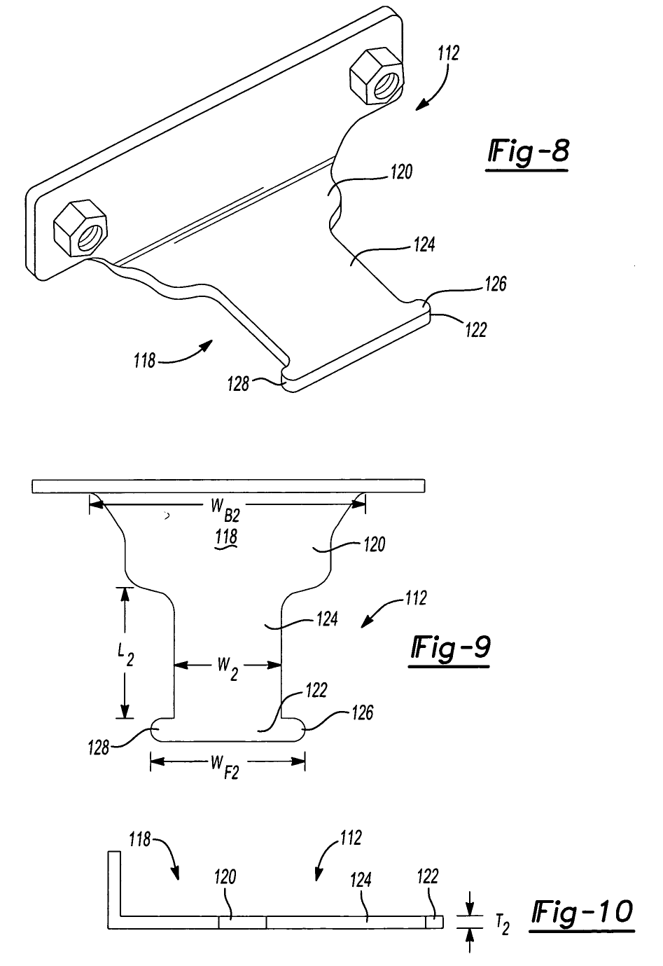

Referring now to FIGS. 2-4 and 8-10, a bracket 112 with a longitudinally-extending tongue 118 can couple engine mount 98 to frame 22. Bracket 112 can be attached to a transversely-extending cross member 114 of frame 22. Tongue 118 can have longitudinally opposite base and end sections 120, 122 with an elongated section 124 extending longitudinally therebetween. Tongue 118 can have a generally uniform thickness T₂ in the vertical direction. Elongated section 124 can have a generally uniform transverse width W₂. Base section 120 can have a maximum transverse width W_{B2} and can taper transversely inwardly as base section 120 approaches elongated section 124. End section 122 can include transversely-outwardly-extending flanges 126, 128 that extend transversely outwardly beyond elongated section 124 and have a transverse width W_{F2}. Flanges 126, 128 can retain tongue 118 in engine mount 98, as described below. Elongated section 124 can have a longitudinal length L₂ between base and end sections 120, 122. Bracket 112 and tongue 118 can be made of steel.

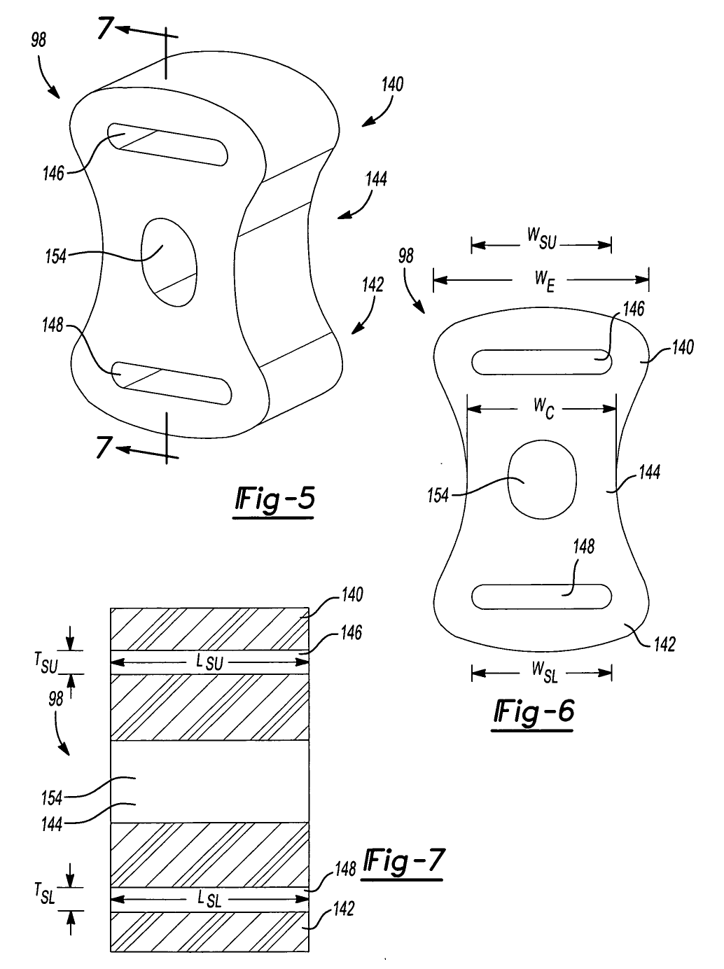

Referring now to FIGS. 5-7, engine mount 98 can include vertically-spaced-apart upper and lower end sections 140, 142 with a central section 144 extending therebetween. Engine mount 98 can be symmetrical about a horizontal plane extending through the center of central section 144 and about a vertical plane extending through the center of engine mount 98. End sections 140, 142 can each include a slot 146, 148 which can be configured to receive tongues 94, 118, respectively. Upper slot 146 can have a transverse width Wₛᵤ, a vertical thickness Tₛᵤ and a longitudinal length Lₛᵤ. The dimensions of upper slot 146 can be chosen to facilitate retention of tongue 94 therein. Similarly, lower slot 148 can have a transverse width Wₛₗ, a vertical thickness Tₛₗ, and a longitudinal length Lₛₗ. The dimensions of lower slot 148 can be chosen to facilitate retention of tongue 118 therein.

Engine mount 98 can be flexible and can undergo both compression and tension due to relative movement between tongues 94, 118 when disposed within slots 146, 148. As such, engine mount 98 can allow some limited relative movement between power unit 60 and frame 22 and can damp vibrations therebetween while inhibiting other relative movement. Engine mount 98 can be made from a variety of materials. By way of non-limiting example, engine mount 98 can be made from natural rubber, urethane, and the like. Engine mount 98, by way of non-limiting example, can have a durometer in the range of 40-60 on the Shore A scale. Engine mount 98 can have durometer of 50 on the Shore A scale.

To insert tongue 94 into upper slot 146, end section 102 is forced through upper slot 146. The width W_{F1} of flanges 106, 108 and the maximum width W_{B1} of base section 100 can be greater than width Wₛᵤof upper slot 146. As a result, end section 102 can deform upper slot 146 as tongue 94 is being inserted therethrough. Tongue 94 can be inserted into upper slot 146 until end section 102 and flanges 106, 108 extend beyond upper slot 146 and elongated section 104 is disposed within upper slot 146. Width W₁ of elongated section 104 can be less than width Wₛᵤ of upper slot 146. Length L₁ of elongated section 104 can be greater than length Lₛᵤ of upper slot 146. The thickness T₁ of tongue 94 can be less than thickness Tₛᵤ of upper slot 146. As a result, engine mount 98 can move along elongated section 104 of tongue 94 between base section 100 and end section 102 with the relative movement limited by the width of flanges 106, 108 and base section 100. Additionally, limited relative rotation can occur between tongue 94 and engine mount 98.

To insert tongue 118 into lower slot 148, end portion 122 is forced through lower slot 148. The width W_{F2} of flanges 126, 128 and the maximum width W_{B2} of base section 120 can be greater than width Wₛₗ of lower slot 148. As a result, end section 122 can deform lower slot 148 until end section 122 and flanges 126, 128 extend beyond slot 148 and elongated section 124 is disposed within lower slot 148. Width W₂ of elongated section 124 can be less than width Wₛₗ of lower slot 148. Thickness T₂ of tongue 118 can be less than thickness Tₛₗ of lower slot 148. Length L₂ of elongated section 124 can be greater than length Lₛₗ of lower slot 148. As a result, engine mount 98 can move along elongated section 124 of tongue 118 between base section 120 and end section 122 with the relative movement limited by the width of flanges 126, 128 and base section 120. Additionally, limited relative rotation can occur between tongue 118 and engine mount 98.

Tongues 94, 118, if desired, can be configured to be the same shape and have the same dimensions. When that is the case, slots 146,148 can also be configured to have the same shape and dimensions. Engine mount 98 can then be attached to tongues 94, 118 with either slot engaging with either tongue. If desired, however, tongues 94, 118 can have different dimensions and the corresponding slots have dimensions that are complementary to those dimensions to allow the associated tongue to be disposed and retained therein. For example, the transverse width W₁ of elongated section 104 of tongue 94 can be greater or less than the transverse width W₂ of elongated section 124 of tongue 118. When this is the case, the width W_{S} of slots 146, 148 can be different than one another or the same and configured to allow the wider elongated section to fit and be retained therein. Thus, it should be appreciated that tongues 94, 118 can be the same or different in dimensions relative to one another. Moreover, it should be appreciated that the dimensions of slots 146, 148 can be the same as or different than one another and are configured to correspond to the associated tongue or the larger of the tongues.

During acceleration and deceleration of vehicle 20, power unit 60 can be induced to rotate about drive axle 66. For example, during forward deceleration, such as when applying the brakes while vehicle 20 is traveling in a forward direction, front portion 90 of engine pan 80 can be rotated downwardly by power unit 60. Similarly, during a forward acceleration, such as when power unit 60 is causing forward acceleration of vehicle 20, front portion 90 of engine pan 80 can be rotated upwardly by power unit 60. The opposite reaction forces can occur when vehicle 20 is being operated in a reverse or backward direction and deceleration due to braking or acceleration is experienced. As a result, relative movement between tongue 94 of engine pan 80 and tongue 118 of bracket 112 during operation of vehicle 20 can occur.

Typically, the forces associated with deceleration due to braking will exceed the forces associated with acceleration of vehicle 20 due to being driven by power unit 60. Typically, vehicle 20 will be operated in a forward direction more often than in a backward direction. As a result, a forward deceleration force can be experienced more frequently than a rearward deceleration force. Thus, the larger and more frequent force imparted due to relative movement between power unit 60 and frame 22 can be caused by forward deceleration due to braking of vehicle 20.

Relative movement between tongues 94, 118 when disposed within engine mount 98 can cause compression or tension of engine mount 98 depending upon the direction of relative movement between the tongues. Tongues 94, 118 can be arranged so that engine mount 98 experiences compression when vehicle 20 is traveling in a forward direction and deceleration occurs. To accomplish this, tongue 94 can be disposed above tongue 118 with tongue 94 in upper slot 146 and tongue 118 disposed in lower slot 148, as shown in FIGS. 2-4. As a result, during forward deceleration tongue 94 can be rotated toward tongue 118 and engine mount 98 will experience a compressive force as it limits the relative movement between tongues 98 and 118. During forward acceleration, the opposite is true and tongue 94 can rotate away from tongue 118 and engine mount 98 will experience a tensile force as it limits the relative movement between tongues 94 and 118. Thus, tongues 94, 118 can be configured so that the largest and most typically-experienced force imparted on engine mount 98 is a compressive force while the smaller and less-frequent force imparted on engine mount 98 is a tensile force.

To facilitate compression of engine mount 98, central section 144 can include a through opening 154 that extends longitudinally through engine mount 98. Opening 154 can form a void within central section 144 that can be deformed due to compressive forces imparted on engine mount 98 through tongues 94, 118. Opening 154 thereby reduces an effective width of central section 144 and facilitates compression of central section 144 as a result of compressive forces being imparted on engine mount 98. The size of opening 154 can vary based upon the expected compressive forces to be imparted on engine mount 98 and the properties of the materials out of which engine mount 98 is made. Additionally, if desired, a plurality of discrete individual through openings could be employed in central section 144 in lieu of the single opening shown.

Central section 144 can have a minimum transverse width W_{C} that is less than a maximum transverse width W_{E} of end sections 140, 142. The reduced width of central section 144 allows a reduction of the overall material used to form engine mount 98 while still accommodating the width of tongues 94, 118 with the wider end sections 140, 142 and the associated slots 146, 148 disposed therein. As a result, the cost of engine mount 98 can be less than that associated with the engine mount having a uniform width throughout.

Engine mount 98 according to the present disclosure can thereby undergo both compression and tension during operation of vehicle 20. The compliant nature of engine mount 98 can allow limited relative movement between power unit 60 and frame 22 in all directions. Engine mount 98 can also damp the movement and vibrations that may be transferred therebetween. Engine mount 98 avoids metal-to-metal contact due to relative movement between power unit 60 and frame 22 and can prevent or minimize wear on any protective coatings on the tongues disposed therein.

The description herein is merely exemplary in nature and, thus, variations that do not depart from the gist of that which is described are intended to be within the scope of the disclosure. Such variations are not to be regarded as a departure from the spirit and scope of the disclosure.

What is claimed is:

1. An engine isolator mount comprising a single resilient member having opposite first and second end sections spaced apart in a first direction with a central section extending therebetween and opposite first and second surfaces spaced apart in a second direction different than the first direction, a width of the central section in a third direction different than both the first and second directions is less than a width of the end sections in the third direction, the first end section having a first through opening extending between the first and second surfaces, the second end section having a second through opening extending between the first and second surfaces, and the first and second openings deforming to allow rigid members to be disposed therethrough and allowing limited relative movement between rigid members disposed therein.

2. The engine isolator mount of claim 1, wherein the first and second end sections have an equal width in the third direction.

3. The engine isolator mount of claim 1, wherein the central section has at least one through opening extending therethrough between the first and second surfaces.

4. The engine isolator mount of claim 1, wherein the single resilient member has a width in a third direction different the first and second directions, the three directions are orthogonal to each other and the single resilient member is symmetrical about a plane defined by any two of the three directions through a center of the single resilient member.

5. The engine isolator mount of claim 1, wherein the first and second openings are identical to one another.

6. The engine isolator mount of claim 1, wherein the single resilient member comprises rubber.

7. The engine isolator mount of claim 1, having a Shore A durometer value between 40 and 60 inclusive.

8. An engine isolating mounting system comprising:
an internal combustion engine assembly having an internal combustion engine and a first tongue member coupled thereto;
a frame having a second tongue member coupled thereto; and
a unitary resilient isolating member having spaced-apart end sections with a central section therebetween, each end section having a through opening extending therethrough with the first and second tongue members each disposed in one of the through openings.

9. The engine isolating mounting system of claim 8, wherein the first tongue member is disposed in an upper one of the through openings and the second tongue member is disposed in a lower one of the through openings.

10. The engine isolating mounting system of claim 9, further comprising an engine pan coupled to the internal combustion engine and the first tongue member extends from the engine pan.

11. The engine isolating mounting system of claim 10, wherein the frame comprises a cross member and the second tongue is coupled to the cross member.

12. The engine isolating mounting system of claim 11, further comprising at least one driven wheel coupled to a drive axle and wherein a portion of the internal combustion engine assembly is coupled to the drive axle and an opposite portion of the internal combustion engine assembly is coupled to the isolating member.

13. The engine isolating mounting system of claim 12, wherein a front portion of the internal combustion engine assembly is coupled to the isolating member and a rear portion of the internal combustion engine assembly is coupled to the drive axle.

14. The engine isolating mounting system of claim 8, wherein the through openings have a first length in a first direction, the tongue members each have a base section, an end section and an elongated section extending therebetween in the first direction, the elongated sections each have a second length in the first direction, the second length is greater than the first length and the end sections and base sections of each tongue member are disposed on opposite sides of the associated through opening with the elongated sections at least partially disposed in the associated through opening.

15. The engine isolating mounting system of claim 14, wherein the through openings have a first width in a second direction orthogonal to the first direction and widths of the elongated sections of the tongue members in the second direction are less than the first width.

16. The engine isolating mounting system of claim 15, wherein widths of the end sections and base sections of the tongue members in the second direction are greater than the first width.

17. The engine isolating mounting system of claim 15, wherein the through openings have a first thickness in a third direction orthogonal to the first and second directions and thicknesses of the elongated sections of the tongue members in the third direction are less than the first thickness.

18. The engine isolating mounting system of claim 15, wherein a width of the central section in the second direction is less than widths of the end sections in the second direction.

19. The engine isolating mounting system of claim 8, wherein the central section of the isolating member includes at least one empty through opening therein.

20. The engine isolating mounting system of claim 8, wherein the isolating member comprises rubber.

21. The engine isolating mounting system of claim 8, wherein the isolating member consists of rubber.

22. The engine isolating mounting system of claim 8, wherein the isolating member has a Shore A durometer value between 40 and 60 inclusive.

23. A small utility vehicle including the engine isolating mounting system of claim 8.

24. A golf car including the engine isolating mounting system of claim 8.

25. A small utility vehicle comprising:
a longitudinally extending frame having a first mounting member coupled thereto;
a drive axle assembly coupled to the frame, the drive axle assembly including at least one transversely-extending drive axle and at least one driven wheel coupled to the at least one drive axle;
an internal combustion engine assembly coupled to the drive axle assembly, the internal combustion engine assembly having a second mounting member coupled thereto; and
a unitary resilient isolating member coupled to the first and second mounting members, the isolating member including upper and lower end sections with a central section extending therebetween, the end sections each having a longitudinally-extending through opening, the first and second mounting members each disposed in and longitudinally extending through different ones of the through openings.

26. The small utility vehicle of claim 25, wherein the first mounting member is disposed in the through opening in the lower end section and the second mounting member is disposed in the through opening in the upper end section.

27. The small utility vehicle of claim 26, further comprising at least one empty through opening extending through the central section of the isolating member.

28. The small utility vehicle of claim 26, wherein the second mounting member is coupled to a front portion of the internal combustion engine assembly and a rear portion of the internal combustion engine assembly is coupled to the drive axle assembly.

29. The small utility vehicle of claim 28, wherein the through openings have a first length in the longitudinal direction, the mounting members each have a base section, an end section and an elongated section extending longitudinally therebetween, the elongated sections each have a second length in the longitudinal direction, the second length is greater than the first length and the end sections and base sections of each mounting member are disposed on opposite sides of the associated through opening with the elongated sections at least partially disposed in the associated through opening.

30. The small utility vehicle of claim 29, wherein the through openings have a first width in a transverse direction orthogonal to the longitudinal direction and widths of the elongated sections of the mounting members in the transverse direction are less than the first width.

31. The small utility vehicle of claim 25, wherein the isolating member comprises rubber.

32. The small utility vehicle of claim 25, wherein the isolating member consists of rubber.

33. The small utility vehicle of claim 25, further comprising a golf car.
